(19) United States
(12) Patent Application Publication
(10) Pub. No.: US 2025/0225698 A1
(43) Pub. Date: Jul. 10, 2025

(54) METHODS AND APPARATUS FOR GENERATING IMAGES FOR AN UPTAKE TIME USING MACHINE LEARNING BASED PROCESSES

(71) Applicant: Siemens Medical Solutions USA, Inc., Malvern, PA (US)

(72) Inventors: Xueqi Guo, New Haven, CT (US); David Pigg, Maryville, TN (US); Lauren Partin, Knoxville, TN (US); Vijay Shah, Knoxville, TN (US)

(21) Appl. No.: 18/408,688

(22) Filed: Jan. 10, 2024

(51) Int. Cl. G06T 11/60; G06V 10/771; G06V 10/82

(52) U.S. Cl. CPC G06T 11/60; G06V 10/771; G06V 10/82

(57) ABSTRACT

Systems and methods that employ machine learning processes for generating medical images associated with a particular uptake time. For instance, the embodiments may apply machine learning processes to positron emission tomography (PET) images captured with a first uptake time to generate output images associated with a second uptake time. In some examples, a system receives PET measurement data characterizing a scanned image of a subject. The system also receives uptake time data characterizing a first uptake time of the scanned image. The system applies a trained machine learning process to the measurement data and the uptake time data and, based on the application of the trained machine learning process to the measurement data and the uptake time data, generates output image data characterizing an output image at a second uptake time. The second uptake time may be greater than the first uptake time of the originally captured PET images.

### FIELD

Aspects of the present disclosure relate in general to medical diagnostic systems and, more particularly, to reconstructing images from nuclear imaging systems for diagnostic and reporting purposes.

### BACKGROUND

Nuclear imaging systems can employ various technologies to capture images. For example, some nuclear imaging systems employ positron emission tomography (PET) to capture images. PET is a nuclear medicine imaging technique that produces tomographic images representing the distribution of positron emitting isotopes within a body. Typically, these nuclear imaging systems capture measurement data, and process the captured measurement data using mathematical algorithms to reconstruct medical images. In PET imaging, standard uptake value (SUV) is a quantitative measurement of the amount of tracer accumulation (e.g., within tissue). As an alternate of the SUV measurement, the standard tumor-to-blood uptake ratio (SUR) is typically defined as the SUV divided by a mean blood pool uptake. Both SUV and SUR can assist in standardizing measurements of tracer uptake among different subjects and PET systems. For instance, the use of SUV can remove variability introduced by differences in patient size and the amount of dosage injected.

However, there are several factors that could influence the SUV and SUR values, such as sources of bias and variance that are introduced in the measurement of dosage uptake, as well as in the computation of SUV and/or SUR values based on image count data. For example, uptake time (e.g., time between tracer injection and image acquisition), varying uptake and clearance tracer rates among subjects and tissues (e.g., tumors), image reconstruction protocols, and other factors may affect the computation of SUV and SUR values. Ideally in a clinic, PET images for subjects should be acquired such that all scans have a same standard uptake time. Practically, however, this is not feasible due to operational, scheduling, and image scanning challenges. As a result, a subject may be scanned at different times, with the scans having differing uptake times. These different uptake times may cause an inaccurate quantification of SUV and SUR, which can negatively impact medical diagnosis and reporting. As such, there are opportunities to address these and other deficiencies in nuclear imaging systems.

### SUMMARY

Systems and methods for harmonizing images to an uptake time using machine learning based processes, and for training the machine learning based processes, are disclosed.

In some embodiments, a computer-implemented method includes receiving measurement data characterizing a scanned image of a subject, and uptake time data characterizing a first uptake time of the scanned image. The method also includes applying a trained machine learning process to the measurement data and the uptake time data and, based on the application of the trained machine learning process to the measurement data and the uptake time data, generating output image data characterizing an output image at a second uptake time. Further, the method includes storing the output image in a data repository.

In some embodiments, a non-transitory computer readable medium stores instructions that, when executed by at least one processor, cause the at least one processor to perform operations. The operations include receiving measurement data characterizing a scanned image of a subject, and uptake time data characterizing a first uptake time of the scanned image. The operations also include applying a trained machine learning process to the measurement data and the uptake time data and, based on the application of the trained machine learning process to the measurement data and the uptake time data, generating output image data characterizing an output image at a second uptake time. Further, the operations include storing the output image in a data repository.

In some embodiments, a system includes a data repository and at least one processor communicatively coupled the data repository. The at least one processor is configured to receive measurement data characterizing a scanned image of a subject, and uptake time data characterizing a first uptake time of the scanned image. The at least one processor is also configured to apply a trained machine learning process to the measurement data and the uptake time data and, based on the application of the trained machine learning process to the measurement data and the uptake time data, generate output image data characterizing an output image at a second uptake time. Further, the at least one processor is configured to store the output image in the data repository.

In some embodiments, a computer-implemented method includes receiving first measurement training data characterizing scanned images associated with a first uptake time, and second measurement training data characterizing scanned images associated with a second uptake time. The method also includes generating first features based on the first measurement training data and second features based on the second measurement training data. Further, the method includes inputting the first features and the second features into a machine learning process and, based on inputting the first features and the second features into the machine learning process, generating output data characterizing a similarity between the first features and the second features. The method also includes determining a loss value based on the output data. Further, the method includes determining the machine learning process is trained based on the loss value. The method also includes storing parameters characterizing the trained machine learning process in a data repository.

In some embodiments, a non-transitory computer readable medium stores instructions that, when executed by at least one processor, cause the at least one processor to perform operations. The operations include receiving first measurement training data characterizing scanned images associated with a first uptake time, and second measurement training data characterizing scanned images associated with a second uptake time. The operations also include generating first features based on the first measurement training data and second features based on the second measurement training data. Further, the operations include inputting the first features and the second features into a machine learning process and, based on inputting the first features and the second features into the machine learning process, generating output data characterizing a similarity between the first features and the second features. The operations also include determining a loss value based on the output data. Further, the operations include determining the machine learning process is trained based on the loss value. The operations also include storing parameters characterizing the trained machine learning process in a data repository.

In some embodiments, a system includes a data repository and at least one processor communicatively coupled the data repository. The at least one processor is configured to receive first measurement training data characterizing scanned images associated with a first uptake time, and second measurement training data characterizing scanned images associated with a second uptake time. The at least one processor is also configured to generate first features based on the first measurement training data and second features based on the second measurement training data. Further, the at least one processor is configured to input the first features and the second features into a machine learning process and, based on inputting the first features and the second features into the machine learning process, generate output data characterizing a similarity between the first features and the second features. The at least one processor is also configured to determine a loss value based on the output data. Further, the at least one processor is configured to determine the machine learning process is trained based on the loss value. The at least one processor is also configured to store parameters characterizing the trained machine learning process in the data repository.

### BRIEF DESCRIPTION OF THE DRAWINGS

The following will be apparent from elements of the figures, which are provided for illustrative purposes and are not necessarily drawn to scale.

FIG. 1 illustrates a nuclear imaging system, in accordance with some embodiments.

FIG. 2 illustrates a block diagram of an example computing device that can perform one or more of the functions described herein, in accordance with some embodiments.

FIG. 3 illustrates a nuclear imaging system, in accordance with some embodiments.

FIGS. 4A and 4B illustrates a machine learning training system, in accordance with some embodiments.

FIGS. 5A, 5B, and 5C illustrate medical images, in accordance with some embodiments.

FIGS. 6A, 6B, and 6C illustrate medical images, in accordance with some embodiments.

FIG. 7 is a flowchart of an example method to generate a medical image at a standard uptake time, in accordance with some embodiments.

FIG. 8 is a flowchart of an example method to train a machine learning process, in accordance with some embodiments.

### DETAILED DESCRIPTION

This description of the exemplary embodiments is intended to be read in connection with the accompanying drawings, which are to be considered part of the entire written description. Independent of the grammatical term usage, individuals with male, female, or other gender identities are included within the term.

The exemplary embodiments are described with respect to the claimed systems as well as with respect to the claimed methods. Furthermore, the exemplary embodiments are described with respect to methods and systems for image reconstruction, as well as with respect to methods and systems for training functions used for image reconstruction. Features, advantages, or alternative embodiments herein can be assigned to the other claimed objects and vice versa. For example, claims for the providing systems can be improved with features described or claimed in the context of the methods, and vice versa. In addition, the functional features of described or claimed methods are embodied by objective units of a providing system. Similarly, claims for methods and systems for training image reconstruction functions can be improved with features described or claimed in context of the methods and systems for image reconstruction, and vice versa.

Various embodiments of the present disclosure can employ machine learning methods or processes to provide clinical information from nuclear imaging systems. For example, the embodiments can employ machine learning methods or processes to reconstruct images based on captured measurement data, and provide the reconstructed images for clinical diagnosis. In some embodiments, machine learning methods or processes are trained, to improve the reconstruction of images.

The embodiments are directed to systems that employ machine learning processes to generate medical images associated with a particular uptake time, thereby allowing for the harmonization of parameters across various images. For instance, the embodiments may apply machine learning processes to positron emission tomography (PET) images (e.g., whole-body PET images) captured at a particular uptake time to generate output images associated with a second uptake time. As such, although the PET images may have been captured with one standard uptake time (e.g., 25 minutes, 45 minutes, etc.), the generated output images correspond to a same particular standard uptake time (e.g., 60 minutes). This allows for the harmonization of computed parameters, such as SUV and SUR parameters, across the generated output images.

In some embodiments, a plurality of medical images (e.g., measurement data, histo-image data, etc.) are received. The plurality of medical images may correspond to images generated based on adjacent scans of a subject by an imaging scanner, such as a PET scanner. Moreover, the plurality of images may have been captured at varying uptake times (e.g., 25 minutes after dosing, 45 minutes after dosing). In addition, uptake time embeddings are generated for the plurality of images based on their corresponding uptake times. The plurality of images and the generated uptake time embeddings are inputted to a trained machine learning model. As described herein, the trained machine learning model may be a neural network (e.g., convolutional neural network), an image classifier (e.g., vision transformer), or any other suitable artificial intelligence or machine learning model that can be trained to output images as described herein. Based on the inputted images and uptake time embeddings, the trained machine learning model outputs an image corresponding to a standard uptake time. For instance, an encoder of a trained machine learning model (e.g., trained neural network) may generate feature maps based on the inputted images. The feature maps may be outputs of convolutional layers representing specific features in the input image. Further, a modulator of the trained machine learning model may modify the feature maps based on the time embeddings. For instance, the modulator may scale the feature maps based on the time embeddings. In addition, a decoder of the trained machine learning model may then generate an output image for a corresponding standard uptake time based on the modified feature maps. For instance, the machine learning model may have been trained to generate output images at a standard uptake time of sixty minutes. The output image may then be displayed to a medical professional for diagnosis and/or reporting.

In some embodiments, the machine learning model is trained based on first images generated from scans captured at various uptake times, and second images generated from scans captured at a standard update time (e.g., 60 minutes). The machine learning model is trained to generate output images corresponding to the standard uptake time. For instance, the machine learning model may be trained within a generative adversarial network (GAN). During training, a first neural network of the GAN (e.g., a generator) generates output images based on inputted training input images and corresponding uptake time embeddings, and provides the output images to a second neural network of the GAN (e.g., a discriminator). The second neural network further receives ground truth images and, based on the received output images from the first neural network and the ground truth images, generates output data characterizing whether a corresponding pair of the received output images and ground truth images are “real” (e.g., nearly the same) or “fake” (e.g., not nearly the same).

In some instances, the input images to the first neural network comprise a first medical image captured at a first scan uptake time (e.g., 60 minutes) and a second medical image captured at a second scan uptake time (e.g., 40 minutes). In other instances, the input images to the first neural network comprise a first medical image captured at the standard update time (e.g., 60 minutes) and one or more additional medical images captured at a different scan uptake time (e.g., 40 minutes). The one or more additional medical images may be based on adjacent scans to the scan corresponding to the first medical image.

In some instances, the second neural network (e.g., the discriminator) may be conditioned upon “real” input images (e.g., 40-minute scanned images). Whether the second neural network is trained with the additional “real” input images or not, the discriminator's goal is to distinguish between a “fake” image and a “real” image (e.g., corresponding to a standard uptake time, such as 60 minutes). In other words, the second neural network's goal is to learn to generate “real” and “fake” classifications. For example, the second neural network may be trained to generate output data predicting “fake” for a pair of inputted fake and real images (e.g., a fake 60 minute uptake time image, and a real 40 minute uptake time image), and predicting “real” for a pair of real images (e.g., a real 60 minute uptake time image, and a real 40 minute uptake time image). In some examples, the second neural network is trained to generate output data predicting “fake” for a single fake 60 minute uptake time image, and predicting “real” for a single real 60 minute uptake time image.

In some training examples, the ground truth images provided to the second neural network (e.g., the discriminator) may include medical images scanned at the standard uptake time (e.g., 60 minutes), and medical images scanned at a different uptake time (e.g., 40 minutes). In one training example, the output images of the first neural network (e.g., the generator) are provided to the second neural network, as well as ground truth images that include medical images scanned at a different uptake time (e.g., 40 minutes). As another example, the output images of the first neural network (e.g., the generator) are provided to the second neural network, as well ground truth images that include medical images scanned at the standard uptake time (e.g., 60 minutes). In some examples, the second neural network is further trained on a corresponding uptake time. For instance, the second neural network may receive a first image from the first neural network, and a ground truth image (e.g., which may be a real of fake pair to the first image), as well as uptake time data characterizing the uptake time associated with the ground truth image.

To determine whether the machine learning model is trained, in some embodiments, one or more losses are computed based on the output data of the second neural network (e.g., the output data generated by the discriminator of the GAN). For instance, and as described herein, the output data may characterize whether a corresponding pair of the output images and ground truth images are “real” (e.g., nearly the same) or “fake” (e.g., not nearly the same). A loss may be computed based on whether the output data correctly has identified each pair of images as “real” or “fake.” The loss may be computed based on any suitable loss function (e.g., image reconstruction loss function), such as any of the mean square error (MSE), mean absolute error (MAE), binary cross-entropy (BCE), Sobel, Laplacian, Focal binary loss function, or an adversarial loss, among others. In some examples, the machine learning model is considered to be trained when the computed loss satisfies a loss threshold value. For instance, if the computed loss at least meets (e.g., is at or below) a corresponding loss threshold value, then a determination is made that the machine learning model is trained. Otherwise, if the computed loss does not at least meet the corresponding loss threshold value, a determination is made that the machine learning model is not trained. In this case, the machine learning model may be trained with further epochs of image data, as described herein, until the loss does at least meet the corresponding loss threshold value. Once trained, the machine learning model may be employed by image reconstruction systems to generate images corresponding to a standard uptake time, for instance.

In some embodiments, the machine learning model may be validated based on additional epochs of image data. The machine learning model may be considered validated when a computed loss satisfies one or more validating loss threshold values, as described herein. If the machine learning model validates (e.g., the validating loss threshold values are satisfied), the machine learning model may be employed by image reconstruction systems to generate images, for instance. Otherwise, if the machine learning model does not validate, then the machine learning model may be further trained as described herein.

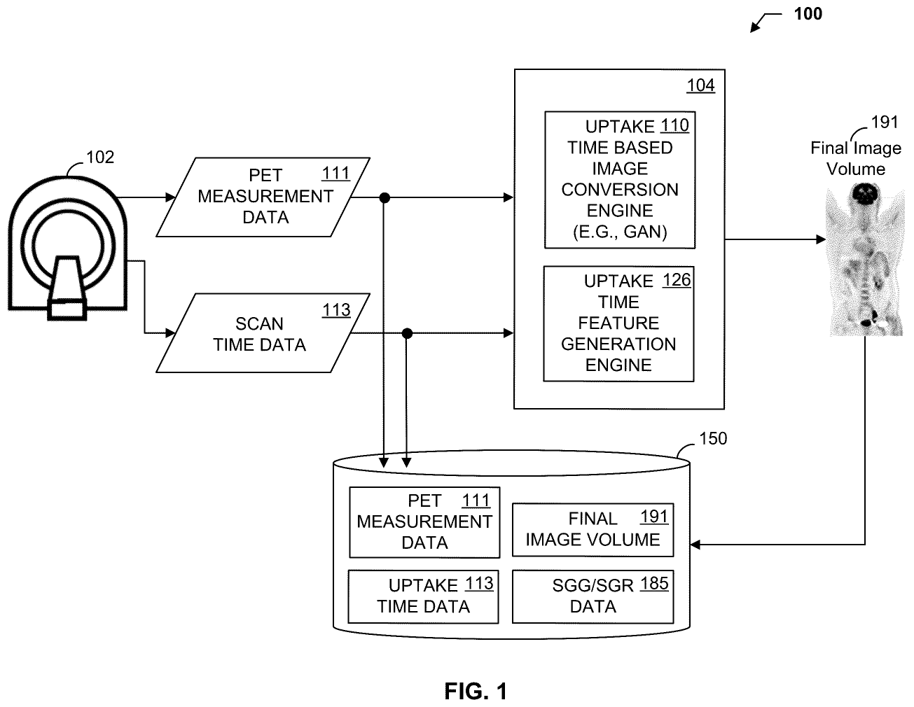

FIG. 1 illustrates a nuclear imaging system 100 that includes image scanning system 102 and image reconstruction system 104. Image scanning system 102 may be PET scanner that can capture PET images, a PET/MR scanner that can capture PET and MR images, a PET/CT scanner that can capture PET and CT images, or any other suitable image scanner. For example, as illustrated, image scanning system 102 can capture PET images (e.g., of a person), and can generate PET measurement data 111 (e.g., PET raw data, such as sinogram data) based on the captured PET images. The PET measurement data 111 (e.g., listmode data) can represent anything imaged in the scanner's field-of-view (FOV) containing positron emitting isotopes. For example, the PET measurement data 111 can represent whole-body image scans, such as image scans from a patient's head to thigh. The scans can be captured at a corresponding uptake time (e.g., 20 minutes after dosage, 45 minutes after dosage, 60 minutes after dosage, etc.). For one or more scans, the image scanning system 102 can generate uptake time data 113 characterizing the uptake time associated with each PET image (e.g., as characterized by corresponding PET measurement data 111).

In some examples, image scanning system 102 may also generate attenuation maps (e.g., u-maps), and can provide the attenuation maps as part of the PET measurement data 111. For instance, the image scanning system 102 may be a PET/CT scanner that, in addition to PET images, can capture CT scans of the patient. The image scanning system 102 may generate the attenuation maps based on the captured CT images. As another example, the image scanning system 102 may be a PET/MR scanner that, in addition to PET images, can capture MR scans of the patient. The image scanning system 102 may generate the attenuation maps based on the captured MR images.

Further, for each scan, image scanning system 102 can store the corresponding PET measurement data 111 (e.g., which may include an attenuation map) and uptake time data 113 within data repository 150. Data repository 150 may be any suitable data storage device, such as a hard drive, a cloud-based data repository, a read-only memory (ROM), any non-volatile memory, a server, or any other suitable storage device.

In some examples, image scanning system 102 transmits the PET measurement data 111 and corresponding uptake time data 113 to image reconstruction system 104 (e.g., over one or more wired or wireless communication busses). As described herein, based on PET measurement data 11 and uptake time data 113, image reconstruction system 104 can generate a final image volume 191 that corresponds to a standard uptake time (e.g., 60 minutes). For instance, while the PET measurement data 111 may correspond to an image scanned at an uptake time of forty minutes, the final image volume 191 may correspond to a standard uptake time of sixty minutes.

In some examples, all or parts of image reconstruction system 104 are implemented in hardware, such as in one or more field-programmable gate arrays (FPGAs), one or more application-specific integrated circuits (ASICs), one or more state machines, one or more computing devices, digital circuitry, or any other suitable circuitry. In some examples, parts or all of image reconstruction system 104 can be implemented in software as executable instructions such that, when executed by one or more processors, cause the one or more processors to perform respective functions as described herein. The instructions can be stored in a non-transitory, computer-readable storage medium, and can be read and executed by the one or more processors.

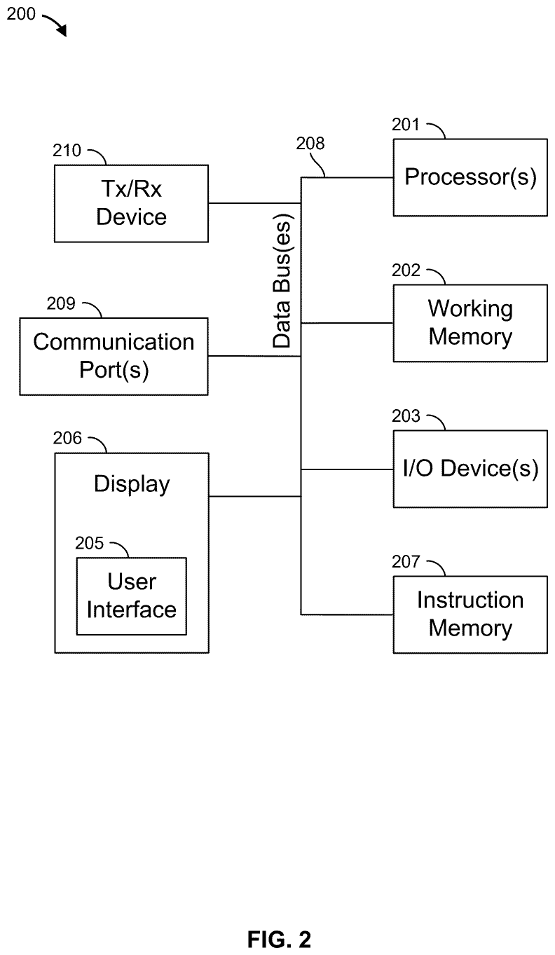

FIG. 2, for example, illustrates a computing device 200 that can be employed by the image reconstruction system 104. Computing device 200 can implement one or more of the functions of the image reconstruction system 104 described herein.

As illustrated, computing device 200 can include one or more processors 201, working memory 202, one or more input/output devices 203, instruction memory 207, a transceiver 210, one or more communication ports 209, and a display 206 that can display a user interface 205, all operatively coupled to one or more data buses 208. Data buses 208 allow for communication among the various components of computing device 200, and can include wired, or wireless, communication channels.

Processors 201 can include one or more distinct processors, each having one or more processing cores. Each of the distinct processors can have the same or different structure. For instance, processors 201 can include one or more of any of central processing units (CPUs), graphics processing units (GPUs), application specific integrated circuits (ASICs), digital signal processors (DSPs), and/or any other suitable processing devices. Each processor 201 can be configured to perform a certain function or operation by executing code, stored on instruction memory 207, that embodies the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, any non-volatile memory, or any other suitable memory. For example, instruction memory 207 can store instructions that, when executed by one or more processors 201, cause one or more processors 201 to perform one or more of the functions of image reconstruction system 104, such as one or more of the machine learning processes and/or forward projection processes described herein.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of computing device 200. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as PET measurement data 111 and/or attenuation maps 105.

Display 206 can display graphical elements of video, such as user interface 205. User interface 205 can enable user interaction with computing device 200. For example, user interface 205 can be a user interface for an application that allows for the viewing of final image volumes 191. In some examples, a user can interact with user interface 205 by engaging input-output devices 203. In some examples, display 206 can be a touchscreen, where user interface 205 is displayed on the touchscreen.

Transceiver 204 allows for communication with a network, such as a Wi-Fi network, an Ethernet network, a cellular network, or any other suitable communication network. For example, if operating in a Wi-Fi network, transceiver 204 is configured to allow communications with the Wi-Fi network. Each of the one or more processors 201 are operable to receive data from, or send data to, the network via transceiver 204.

Referring back to FIG. 1, image reconstruction system 104 includes uptake time based image conversion engine 110 and uptake time feature generation engine 126. One or more of uptake time based image conversion engine 110 and uptake time feature generation engine 126 may be implemented in hardware (e.g., digital logic), software, or in any combination thereof. For instance, one or more functions of any of uptake time based image conversion engine 110 and uptake time feature generation engine 126 can be implemented by one or more processors, such as processor 201, executing instructions, such as instructions stored in instruction memory 207.

Uptake time feature generation engine 126 can receive uptake time data 113 (e.g., from image scanning system 102 or from data repository 150), and can generate uptake time embeddings based on the uptake time data 113. For instance, uptake time feature generation engine 126 may generate uptake time vectors based on the uptake time data 113. An uptake time vector may identify an uptake time for one or more corresponding images. Further, uptake time feature generation engine 126 may apply a recurrent neural network (RNN), such as an Long short-term memory (LSTM) network, to the generated uptake time vectors to generate uptake time embeddings.

Further, uptake time based image conversion engine 110 can receive PET measurement data 111 (e.g., from image scanning device 102 or from data repository 150) characterizing one or more scanned images, and the uptake time features generated by the uptake time feature generation engine 126 for each of the scanned images. In addition, uptake time based image conversion engine 110 can apply a trained machine learning process to the PET measurement data 111 and uptake time features corresponding to one or more scanned images. For instance, uptake time based image conversion engine 110 may receive first PET measurement data 111 and first uptake time features for a first image scanned at an uptake time (e.g., 40 minutes), and second PET measurement data 111 and second uptake time features for a second image also scanned at the uptake time. The second image may be based on an adjacent scan to the scan of the first image. Uptake time based image conversion engine 110 may apply the trained machine learning process to the first PET measurement data 111, the first uptake time features, the second PET measurement data 111, and the second uptake time features.

In some instances, uptake time based image conversion engine 110 also receives third PET measurement data 111 and corresponding third uptake time features for a third image also scanned at the uptake time. The third image may also be an adjacent scan to the scan of the first image. In this example, time conversion engine 110 may apply the trained machine learning process to the first PET measurement data 111, the first uptake time features, the second PET measurement data 111, the second uptake time features, the third PET measurement data 111, and the second uptake time features. Similarly, in other examples, time conversion engine 110 may apply the trained machine learning process to PET measurement data 111 and uptake time features corresponding to any number of scanned images (e.g., one, four, etc.).

Based on the application of the trained machine learning process to the PET measurement data 111 and the uptake time features, uptake time based image conversion engine 110 can generate a final image volume 191 associated with a standard uptake time. The trained machine learning process is trained to generate final image volumes 191 at the particular standard uptake time. The standard uptake time may differ (e.g., be greater than) than the uptake time associated with any of the PET measurement data 111 and corresponding uptake time features to which the uptake time based image conversion engine 110 applied the trained machine learning process to. For instance, PET measurement data 111 may correspond to one or more PET images scanned at an uptake time (e.g., 25 minutes) that is less than the standard uptake time (e.g., 60 minutes) of the final image volume 191. In generating final image volumes 191 at a standard uptake time, the uptake time feature generation engine 126 harmonizes images scanned at various uptake times to the standard uptake time.

In some examples, the trained machine learning process comprises a neural network that is trained to generate final image volumes 191 that correspond to a particular standard uptake time. For instance, the neural network may include an encoder, a modulator, and a decoder. The encoder may generate feature maps based on the PET measurement data 111 received for the one or more scanned images, and may provide the generated feature maps to the modulator (e.g., a modulator configured to execute feature-wise linear modulation (FILM)). Further, the encoder may provide skip connections to the decoder. The modulator may modify the received feature maps based on the uptake time features. For instance, the modulator may scale the feature maps based on the values of the uptake time features. As an example, the modulator may scale the feature maps by a first amount for a first value of the uptake time features, and may scale the feature maps by a second amount for a second value of the uptake time features. The decoder receives the modified feature maps, and performs decoding operations to generate the final image volume 191. In addition, uptake time based image conversion engine 110 may store the final image volume 191 in data repository 150. In some examples, image reconstruction system 104 computes of SUV and/or SUR values based on the final image volume 191, and stores the SUV and/or SUR values as SUV/SUR data 185 in data repository 150.

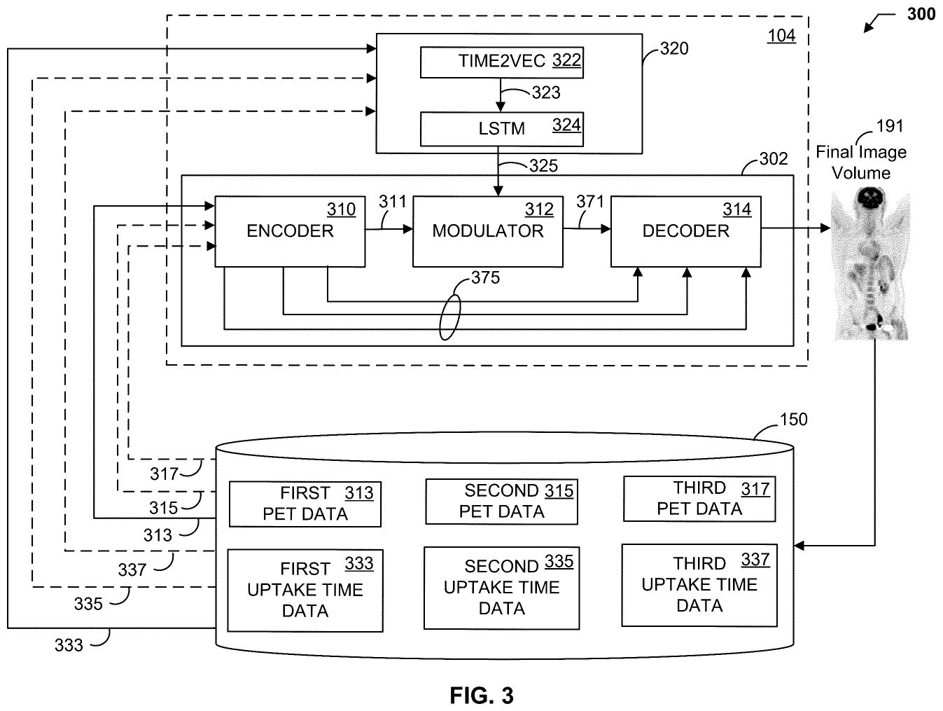

FIG. 3 illustrates a nuclear imaging system 300 that includes a uptake time feature generation network 320 and an uptake time based convolutional neural network 302 that can be implemented by, for instance, the image reconstruction system 104 of FIG. 1. For instance, the uptake time feature generation network 320 may be executed by the uptake time feature generation engine 126 of the image reconstruction system 104, and the uptake time based convolutional neural network 302 may be executed by the uptake time based image conversion engine 110 of the image reconstruction system 104.

In this example, data repository 150 stores first PET data 313 and first uptake time data 333. First PET data 313 may include measurement data characterizing an image scanned by a PET imaging device at an uptake time identified by the first uptake time data 333. Similarly, data repository 150 can store additional PET data and corresponding uptake time data, such as second PET data 315 and second uptake time data 335, and third PET data 317 and third uptake time data 337. In some examples, first PET data 313, second PET data 315, and/or third PET data 317 are based on adjacent scans taken of a subject.

As illustrated, uptake time feature generation network 320 can receive, from data repository 150, uptake time data for one or more scanned images. For instance, uptake time feature generation network 320 may obtain first uptake time data 333 and, optionally, one or more of second uptake time data 335 and third uptake time data 337, from data repository 150. Uptake time feature generation network 320 may apply a time2Vec 322 process to the received uptake time data (e.g., the first uptake time data 333 and, optionally, the one or more of second uptake time data 335 and third uptake time data 337) to generate corresponding uptake time vectors 323. Further, uptake time feature generation network 320 may apply a recurrent neural network (RNN) process, such as an LSTM 324 process, to the uptake time vectors 323 to generate uptake time embeddings 325. In some instances, the LSTM 324 process is trained based on training data comprising uptake time vectors identifying various scan uptake times, and may be trained until one or more loss thresholds are satisfied, as described herein.

As illustrated, uptake time based convolutional neural network 302 includes an encoder 310, a modulator 312, and a decoder 314. In addition, the encoder 310 may output one or more skip connections 375 to the decoder 314. The skip connections 375 provide encoded features to the decoder 314. For instance, a convolutional layer of encoder 310 may provide, via a skip connection 375, an encoded feature to a corresponding convolutional layer of the decoder 314 for decoding. The encoder 310 obtains first PET data 313 and, optionally, one or more of second PET data 315 and third PET data 317, and generates final encoded features 311 (e.g., feature maps) based on the first PET data 313 and, optionally, one or more of second PET data 315 and third PET data 317. The encoder 310 provides the final encoded features 311 to the modulator 312.

Further, the modulator 312 modifies the final encoded features 311 based on the uptake time embeddings 325 to generate modified features 371. For instance, to generate a modified feature 371, the modulator 312 may scale one or more final encoded features 311 (e.g., feature maps) based on the value of a uptake time embedding 325. The modulator 312 provides the modified features 371 to the decoder 314. The decoder 314 receives the modified features 371 and, in some examples, encoded features from the encoder 310 via one or more skip connections 375, and performs operations to decode the modified features 371 and, in some examples, any encoded features received from the encoder 310 via the one or more skip connections. Based on the decoding operations, the decoder 314 generates the final image volume 191. Uptake time based convolutional neural network 302 may store the final image 191 in the data repository 150.

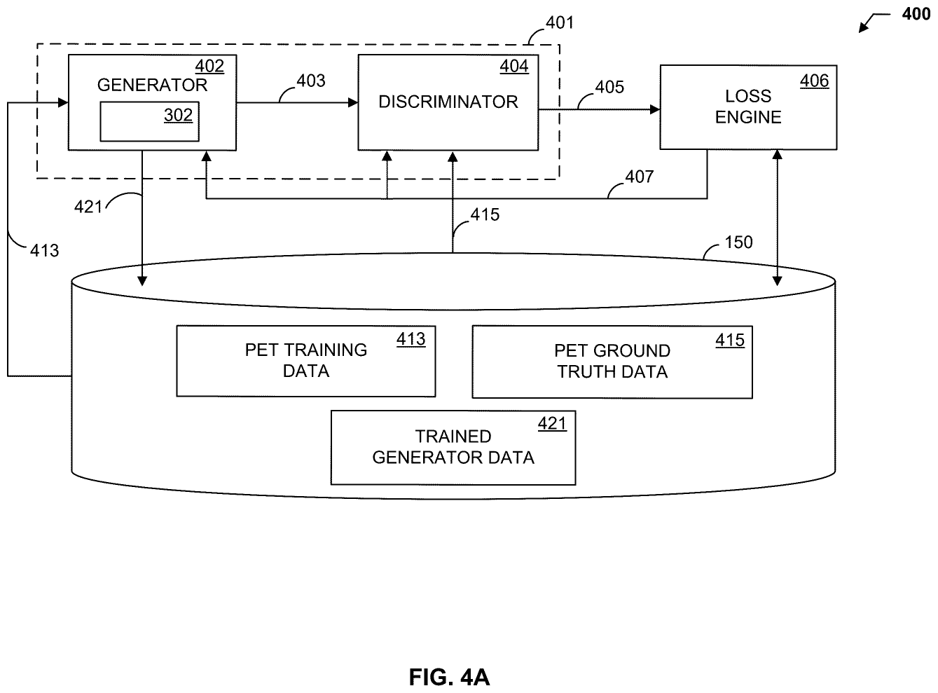

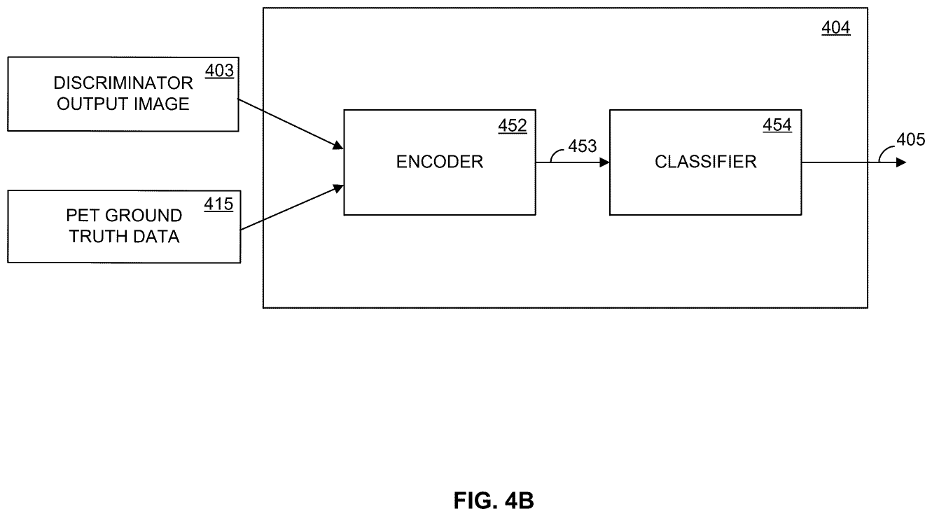

FIG. 4A illustrates a uptake time based neural network training system 400, which can train a uptake time based neural network, such as the uptake time based convolutional neural network 302 of FIG. 3. As illustrated, a generative adversarial network (GAN) 401 may include a generator 402 and a discriminator 404. In some examples, the uptake time based convolutional neural network 302 may serve as the generator 402 within the GAN 401.

As illustrated, data repository 150 includes PET training data 413, and PET ground truth data 415. PET training data 413 may include medical images scanned at various uptake times. For instance, PET training data 413 may include PET images scanned at 20 minute uptake times, 40 minute uptake times, and 45 minute uptake times, among others. In at least some examples, the PET training data 413 includes medical images scanned at a standard uptake time for which the GAN is to be trained (e.g., 60 minute standard uptake time). generator 402 may receive PET training data 413 characterizing one or more medical images such as, for instance, two medical images. The images may be scanned at similar, or varying, uptake times. For instance, the medical images may be adjacent scans of a subject. The generator 402 may generate features based on the PET training data 413, and may generate a generator output image 403 based on the features for the two input medical images. For instance, and as described herein, the output image 403 may be generated by the uptake time based convolutional neural network 302 as described with respect to FIG. 3.

Further, the discriminator 404 receives the output image 403 from the generator 402, and further obtains PET ground truth data 415 characterizing a medical image scanned at a standard uptake time, such as 60 minutes. The discriminator 404 (e.g., classifier) may generate features based on the output image 403 and the PET ground truth data 415 and, based on the features, may generate output classification data 405 indicating whether the output image 403 and the medical image characterized by the PET ground truth data 415 are similar (e.g., “real”), or not similar (e.g., “fake”)

For instance, FIG. 4B illustrates an example of discriminator 404. As illustrated, the discriminator 404 includes an encoder 452 that generates encoded features 453 based on the output image 403 and the medical image characterized by the PET ground truth data 415. A classifier 454 receives the encoded features 453 and applies a classification process to the encoded features 453 to generate the output classification data 405. The classifier 454 may include, for example, one or more fully connected layers (e.g., dense layers, linear layers). In some examples, the classification process may be based on feature-wise linear modulation. For instance, if the discriminator is conditioned upon the uptake time, the classifier 454 may apply a feature-wise linear modulation process to the encoded features 453 to generate the output classification data 405.

Referring back to FIG. 4A, loss engine 406 receives the output classification data 405 from the discriminator 404, and may further one or more of the PET training data 413 and PET ground truth data 415 (e.g., corresponding to the medical image received by the discriminator 404) from the data repository 150. Further, loss engine 406 generates a discriminator loss, and a generator loss, based on whether the output classification data 405 correctly identifies whether the output image 403 and the medical image characterized by the PET ground truth data 415 are similar or not. Loss engine 406 may compute the discriminator loss and generator loss based on any suitable loss function (e.g., image reconstruction loss function), such as any of the mean square error (MSE), mean absolute error (MAE), binary cross-entropy (BCE), Sobel, Laplacian, Focal binary loss function, or an adversarial loss, among others. In some examples, the loss engine 406 generates the generator loss based on MSE, and the discriminator loss based on an adversarial loss.

In some instances, if the generator loss is above a generator loss threshold value (e.g., indicating output classification data 405 is not accurate), the loss engine 406 generates adjustment data 407 characterizing updates to parameters (e.g., hyperparameters, coefficients, weights, etc.) of the neural network of the generator 402 (e.g., weights of the uptake time based convolutional neural network 302), and transmits the adjustment data 407 to the generator 402, causing the generator 402 to update its parameters accordingly. In some instances, if the discriminator loss is above a discriminator loss threshold value (e.g., indicating output classification data 405 is not accurate), the loss engine 406 generates adjustment data 407 characterizing updates to parameters of the neural network of the discriminator (e.g., weight of the uptake time based convolutional neural network 302), and transmits the adjustment data 407 to the discriminator 404, causing the discriminator 404 to update its parameters accordingly.

In some instances, the discriminator 404 is trained until the discriminator loss is below the discriminator loss threshold value. Once the discriminator 404 is trained, the generator 402 is trained until the generator loss is below the generator loss threshold value. Once the generator 402 is trained, the generator 402 stores its parameters as trained generator data 421 within data repository 150. The trained generator 402 may be established based on trained generator data 421. Once established, the trained generator 402 may be employed to generate medical images at a particular uptake time, such as the uptake time for which the generator 402 was trained.

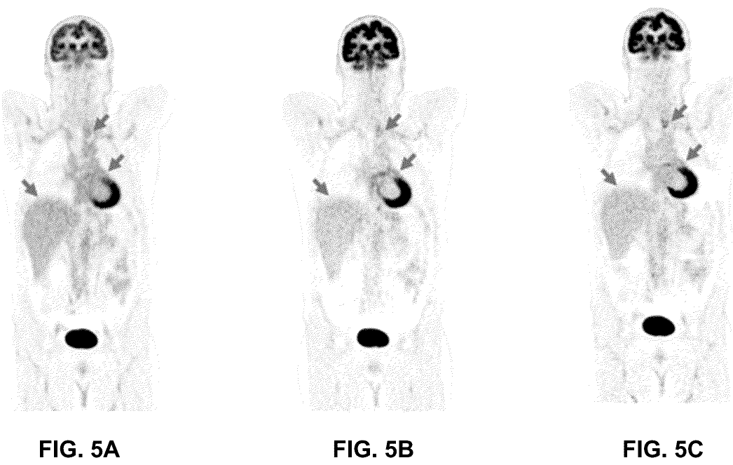

FIGS. 5A, 5B, and 5C illustrate various medical images where the darker portions illustrate higher counts. FIG. 5A, for instance, illustrates a coronal slice of a subject scanned at an uptake time of 25 minutes. FIG. 5B illustrates a coronal slice of the same subject, but scanned at standard uptake time of 60 minutes. FIG. 5C illustrates a coronal slice generated by the processes described herein, such as according to the processes of uptake time based convolutional neural network 302. The coronal slice of FIG. 5C was generated based on the coronal slice of FIG. 5A, and predicts the coronal slice of FIG. 5B. In other words, FIG. 5C illustrates the coronal slice of FIG. 5A, but as if captured at the standard uptake time of 60 minutes. The arrows in FIGS. 5A, 5B, and 5C illustrate regions of interest. As indicated at least by these regions of interest, the generated coronal slice of FIG. 5C is much more similar to the coronal slice of FIG. 5B than is the coronal slice of FIG. 5A.

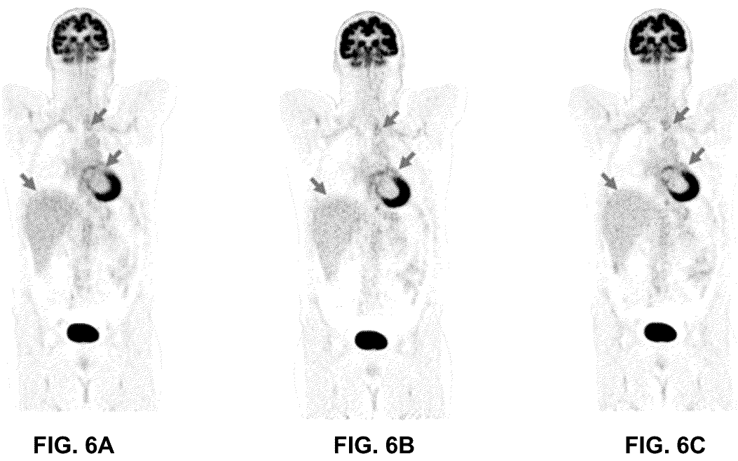

Similarly, FIGS. 6A, 6B, and 6C illustrate various medical images where the darker portions illustrate higher counts. FIG. 6A, for instance, illustrates a coronal slice of a subject scanned at an uptake time of 40 minutes. FIG. 6B illustrates a coronal slice of the same subject, but scanned at standard uptake time of 60 minutes. FIG. 6C illustrates a coronal slice generated by the processes described herein, such as according to the processes of uptake time based convolutional neural network 302. The coronal slice of FIG. 6C was generated based on the coronal slice of FIG. 6A, and predicts the coronal slice of FIG. 6B. In other words, FIG. 6C illustrates the coronal slice of FIG. 6A, but as if captured at the standard uptake time of 60 minutes. The arrows in FIGS. 6A, 6B, and 6C illustrate regions of interest. As indicated at least by these regions of interest, the generated coronal slice of FIG. 6C is much more similar to the coronal slice of FIG. 6B than is the coronal slice of FIG. 6A.

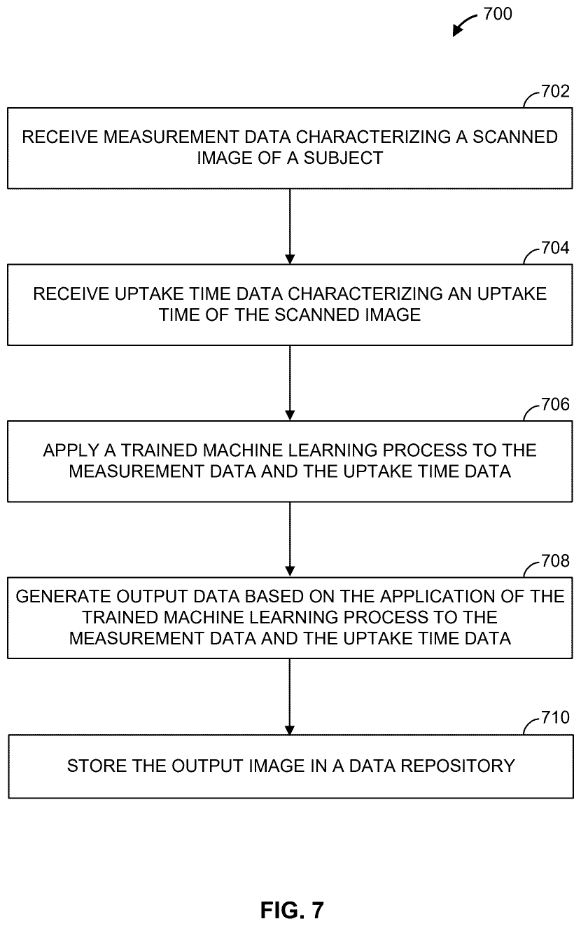

FIG. 7 illustrates a flowchart of an example method 700 to generate a medical image at a standard uptake time. The method can be performed by one or more computing devices, such as computing device 200, executing corresponding instructions, such as instructions stored in instruction memory 207.

Beginning at block 702, measurement data characterizing a scanned image of a subject is received. For example, image reconstruction system 104 may receive PET measurement data 111 from data repository 150. Further, at block 704, uptake time data characterizing an uptake time of the scanned image is received. For instance, image reconstruction system 104 may receive uptake time data 113 from data repository 150.

At block 706, a trained machine learning process is applied to the measurement data and the uptake time data. For instance, and as described herein, image reconstruction system 104 may input PET measurement data 111 and uptake time data 113 to uptake time based convolutional neural network 302. Uptake time based convolutional neural network 302 may generate feature maps based on the PET measurement data 111, and may adjust the feature maps based on the uptake time data 113.

Further, at block 708, output data is generated based on the application of the trained machine learning process to the measurement data and the uptake time data. The output image data characterizes an output image at a second uptake time, such as a standard uptake time of 60 minutes. For example, uptake time based convolutional neural network 302 may generate the final image volume 191 based on the modified feature maps. At block 710, the output image is stored in a data repository.

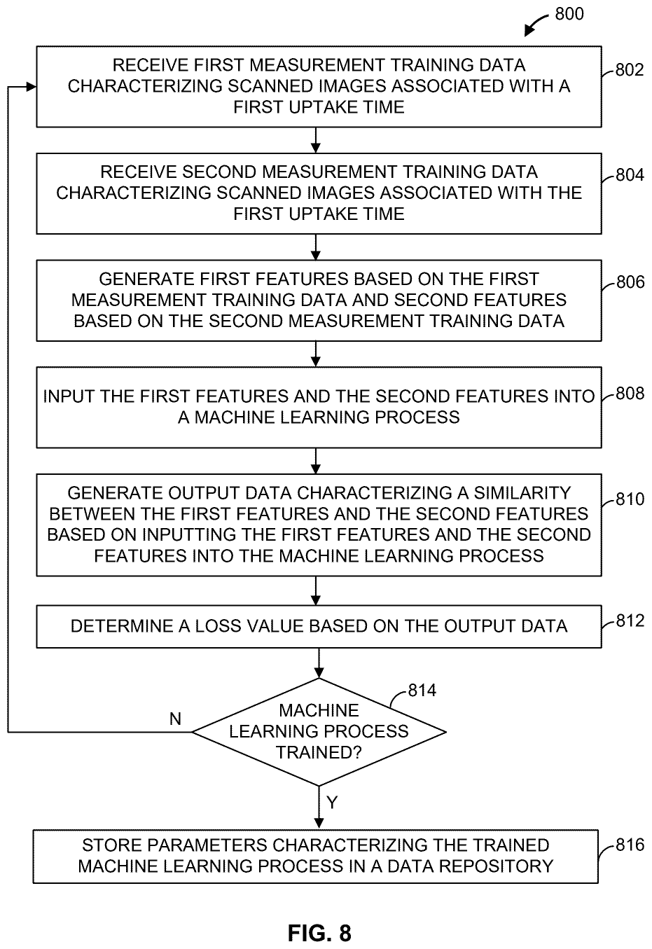

FIG. 8 is a flowchart of an example method 800 to train a machine learning process to generate output images at a particular uptake time, such as a standard uptake time. The method can be performed by one or more computing devices, such as computing device 200, executing corresponding instructions, such as instructions stored in instruction memory 207.

Beginning at block 802, first measurement training data characterizing scanned images associated with a first uptake time is received. The first measurement training data may characterize images scanned at an uptake time of 40 minutes, for instance. At block 804, second measurement training data characterizing scanned images associated with a second uptake time are also received. The second measurement training data may characterize ground truth images scanned at a standard uptake time of 60 minutes, for instance.

Further, at block 806, first features are generated based on the first measurement training data, and second features are generated based on the second measurement training data. At block 808, the first features and the second features are inputted into a machine learning process. For instance, as described herein, features generated from PET training data 413 and PET ground truth data 415 are inputted into the GAN 401 to train generator 402 and/or discriminator 404.

Further, at block 810, based on inputting the first features and the second features into the machine learning process, output data is generated characterizing a similarity between the first features and the second features. The output data may characterize whether a corresponding pair of the scanned images characterized by the first measurement training data and the second measurement training data are “real” or “fake.” For example, and as described herein, generator 402 may receive PET training data 413 and may generate features based on the PET training data 413. Further, the generator 402 may generate output image 403 based on the features. In addition, the discriminator 404 receives the output image 403 from the generator 402, and further obtains PET ground truth data 415. The discriminator 404 may generate features based on the output image 403 and the PET ground truth data 415 and, based on the features, may generate output classification data 405 indicating whether the output image 403 and the medical image characterized by the PET ground truth data 415 are similar (e.g., “real”), or not similar (e.g., “fake”).

Proceeding to block 812, a loss value is generated based on the output data. For instance, as described herein, loss engine 406 generates one or more losses based on whether the output classification data 405 correctly identifies whether the output image 403 and the medical image characterized by the PET ground truth data 415 are similar or not. The loss value may be computed based on any suitable loss function (e.g., image reconstruction loss function), such as any of the mean square error (MSE), mean absolute error (MAE), binary cross-entropy (BCE), Sobel, Laplacian, Focal binary loss function, or an adversarial loss, among others.

At block 814, a determination is made as to whether the machine learning process is trained based on the loss value. For instance, the machine learning process may be considered trained when the loss value is below a loss threshold value. If the machine learning process is not trained, the method proceed back to block 802 to continue training the machine learning process. Otherwise, if the machine learning process is trained, the method proceeds to block 816. At block 816, parameters characterizing the trained machine learning process are stored in a data repository, such as data repository 150.

For instance, the parameters may be stored as trained generator data 421 within data repository 150. The trained machine learning process may be established based on the stored parameters. Once established, the trained machine learning process may be employed to generate medical images at a particular uptake time, such as the uptake time for which the machine learning process was trained.

The following is a list of non-limiting illustrative embodiments disclosed herein:

Illustrative Embodiment 1: A computer-implemented method comprising:
receiving measurement data characterizing a scanned image of a subject;
receiving uptake time data characterizing a first uptake time of the scanned image;
applying a trained machine learning process to the measurement data and the uptake time data and, based on the application of the trained machine learning process to the measurement data and the uptake time data, generating output image data characterizing an output image at a second uptake time; and
storing the output image in a data repository.

Illustrative Embodiment 2: The computer-implemented method of illustrative embodiment 1, wherein applying the trained machine learning process to the measurement data and the uptake time data comprises:
generating feature maps based on the measurement data; and
modifying the feature maps based on the uptake time data.

Illustrative Embodiment 3: The computer-implemented method of illustrative embodiment 2, further comprising inputting the measurement data to a neural network, the neural network configured to generate the feature maps based on the measurement data.

Illustrative Embodiment 4: The computer-implemented method of illustrative embodiment 3, wherein the neural network comprises an encoder and a modulator, the computer-implemented method further comprising:
inputting the measurement data to the encoder;
generating, by the encoder, the feature maps; and
modifying, by the modulator, the feature maps based on the uptake time data.

Illustrative Embodiment 5: The computer-implemented method of illustrative embodiment 4, wherein the neural network comprises a decoder, the computer-implemented method further comprising:
receiving, by the decoder, the modified feature maps; and
generating, by the decoder, the output image data based on the modified feature maps.

Illustrative Embodiment 6: The computer-implemented method of illustrative embodiment 5, further comprising:
receiving, by the decoder, encoded features from the encoder; and
generating, by the decoder, the output image data based on the encoded features.

Illustrative Embodiment 7: The computer-implemented method of any of illustrative embodiments 1-6, wherein the second uptake time is greater than the first uptake time.

Illustrative Embodiment 8: The computer-implemented method of any of illustrative embodiments 1-6, wherein the second uptake time is less than the first uptake time.

Illustrative Embodiment 9: The computer-implemented method of any of illustrative embodiments 1-8, wherein applying the trained machine learning process to the measurement data and the uptake time data further comprises:
generating uptake time vectors based on the uptake time data;
inputting the uptake time vectors to a neural network; and
based on inputting the uptake time vectors to the neural network, generating uptake time embeddings.

Illustrative Embodiment 10: The computer-implemented method of illustrative embodiment 8, further comprising:
generating maps based on the measurement data; and
generating modified feature maps based on the uptake time embeddings.

Illustrative Embodiment 11: The computer-implemented method of any of illustrative embodiments 1-10, further comprising providing the output image for display.

Illustrative Embodiment 12: The computer-implemented method of any of illustrative embodiments 1-11, wherein the trained machine learning process is based on a trained convolutional neural network.

Illustrative Embodiment 13: A non-transitory computer readable medium storing instructions that, when executed by at least one processor, cause the at least one processor to perform operations comprising:
receiving measurement data characterizing a scanned image of a subject;
receiving uptake time data characterizing a first uptake time of the scanned image;
applying a trained machine learning process to the measurement data and the uptake time data and, based on the application of the trained machine learning process to the measurement data and the uptake time data, generating output image data characterizing an output image at a second uptake time; and
storing the output image in a data repository.

Illustrative Embodiment 14: The non-transitory computer readable medium of illustrative embodiment 13 storing further instructions that, when executed by the at least one processor, further cause the at least one processor to perform operations comprising:
generating feature maps based on the measurement data; and
modifying the feature maps based on the uptake time data.

Illustrative Embodiment 15: The non-transitory computer readable medium of illustrative embodiment 14 storing further instructions that, when executed by the at least one processor, further cause the at least one processor to perform operations comprising inputting the measurement data to a neural network, the neural network configured to generate the feature maps based on the measurement data.

Illustrative Embodiment 16: The non-transitory computer readable medium of illustrative embodiment 15, wherein the neural network comprises an encoder and a modulator, and wherein the non-transitory computer readable medium is storing further instructions that, when executed by the at least one processor, further cause the at least one processor to perform operations comprising:
inputting the measurement data to the encoder;
generating, by the encoder, the feature maps; and
modifying, by the modulator, the feature maps based on the uptake time data.

Illustrative Embodiment 17: The non-transitory computer readable medium of illustrative embodiment 16, wherein the neural network comprises a decoder, and wherein the non-transitory computer readable medium is storing instructions that, when executed by the at least one processor, further cause the at least one processor to perform operations comprising:
receiving, by the decoder, the modified feature maps; and
generating, by the decoder, the output image data based on the modified feature maps.

Illustrative Embodiment 18: The non-transitory computer readable medium of illustrative embodiment 17 storing further instructions that, when executed by the at least one processor, further cause the at least one processor to perform operations comprising:
receiving, by the decoder, encoded features from the encoder; and
generating, by the decoder, the output image data based on the encoded features.

Illustrative Embodiment 19: The non-transitory computer readable medium of any of illustrative embodiments 13-18 storing further instructions that, when executed by the at least one processor, further cause the at least one processor to perform operations comprising:
generating uptake time vectors based on the uptake time data;
inputting the uptake time vectors to a neural network; and
based on inputting the uptake time vectors to the neural network, generating uptake time embeddings.

Illustrative Embodiment 20: The non-transitory computer readable medium of illustrative embodiment 19 storing further instructions that, when executed by the at least one processor, further cause the at least one processor to perform operations comprising:
generating maps based on the measurement data; and
generating modified feature maps based on the uptake time embeddings.

Illustrative Embodiment 21: The non-transitory computer readable medium of any of illustrative embodiments 13-20, wherein the second uptake time is greater than the first uptake time.

Illustrative Embodiment 22: The non-transitory computer readable medium of any of illustrative embodiments 13-20, wherein the second uptake time is less than the first uptake time.

Illustrative Embodiment 23: The non-transitory computer readable medium of any of illustrative embodiments 13-22 storing further instructions that, when executed by the at least one processor, further cause the at least one processor to perform operations comprising providing the output image for display.

Illustrative Embodiment 24: The non-transitory computer readable medium of any of illustrative embodiments 13-23, wherein the trained machine learning process is based on a trained convolutional neural network.

Illustrative Embodiment 25: A system comprising:
a data repository; and
at least one processor communicatively coupled to the data repository, the at least one processor configured to:
   receive measurement data characterizing a scanned image of a subject;
   receive uptake time data characterizing a first uptake time of the scanned image;
   apply a trained machine learning process to the measurement data and the uptake time data and, based on the application of the trained machine learning process to the measurement data and the uptake time data, generating output image data characterizing an output image at a second uptake time; and
   store the output image in the data repository.

Illustrative Embodiment 26: The system of illustrative embodiment 25, wherein the at least one processor configured to:
generate feature maps based on the measurement data; and
modify the feature maps based on the uptake time data.

Illustrative Embodiment 27: The system of illustrative embodiment 26, wherein the at least one processor configured to input the measurement data to a neural network, the neural network configured to generate the feature maps based on the measurement data.

Illustrative Embodiment 28: The system of illustrative embodiment 27, wherein the neural network comprises an encoder and a modulator, the at least one processor configured to:
input the measurement data to the encoder;
cause the encoder to generate the feature maps; and
cause the encoder to modify the feature maps based on the uptake time data.

Illustrative Embodiment 29: The system method of illustrative embodiment 28, wherein the neural network comprises a decoder, the at least one processor configured to cause the decoder to:
receive the modified feature maps; and
generate the output image data based on the modified feature maps.

Illustrative Embodiment 30: The system of illustrative embodiment 29, wherein the at least one processor is configured to cause the decoder to:
receive encoded features from the encoder; and
generate the output image data based on the encoded features.

Illustrative Embodiment 31: The system of any of illustrative embodiments 25-30, wherein the second uptake time is greater than the first uptake time.

Illustrative Embodiment 32: The system of any of illustrative embodiments 25-30, wherein the second uptake time is less than the first uptake time.

Illustrative Embodiment 33: system of any of illustrative embodiments 25-32, wherein the at least one processor is configured to:
generate uptake time vectors based on the uptake time data;
input the uptake time vectors to a neural network; and
based on inputting the uptake time vectors to the neural network, generate uptake time embeddings.

Illustrative Embodiment 34: The system of illustrative embodiment 33, wherein the at least one processor is configured to:
generate maps based on the measurement data; and
generate modified feature maps based on the uptake time embeddings.

Illustrative Embodiment 35: The system of any of illustrative embodiments 25-34, wherein the at least one processor is configured to provide the output image for display.

Illustrative Embodiment 36: The system of any of illustrative embodiments 25-35, wherein the trained machine learning process is based on a trained convolutional neural network.

The apparatuses and processes are not limited to the specific embodiments described herein. In addition, components of each apparatus and each process can be practiced independent and separate from other components and processes described herein.

The previous description of embodiments is provided to enable any person skilled in the art to practice the disclosure. The various modifications to these embodiments will be readily apparent to those skilled in the art, and the generic principles defined herein can be applied to other embodiments without the use of inventive faculty. The present disclosure is not intended to be limited to the embodiments shown herein, but is to be accorded the widest scope consistent with the principles and novel features disclosed herein.

What is claimed is:

1. A computer-implemented method comprising:
receiving measurement data characterizing a scanned image of a subject;
receiving uptake time data characterizing a first uptake time of the scanned image;
applying a trained machine learning process to the measurement data and the uptake time data and, based on the application of the trained machine learning process to the measurement data and the uptake time data, generating output image data characterizing an output image at a second uptake time; and
storing the output image in a data repository.

2. The computer-implemented method of claim 1, wherein applying the trained machine learning process to the measurement data and the uptake time data comprises:
generating feature maps based on the measurement data; and
modifying the feature maps based on the uptake time data.

3. The computer-implemented method of claim 2, further comprising inputting the measurement data to a neural network, the neural network configured to generate the feature maps based on the measurement data.

4. The computer-implemented method of claim 3, wherein the neural network comprises an encoder and a modulator, the computer-implemented method further comprising:
inputting the measurement data to the encoder;
generating, by the encoder, the feature maps; and
modifying, by the modulator, the feature maps based on the uptake time data.

5. The computer-implemented method of claim 4, wherein the neural network comprises a decoder, the computer-implemented method further comprising:
receiving, by the decoder, the modified feature maps; and
generating, by the decoder, the output image data based on the modified feature maps.

6. The computer-implemented method of claim 5, further comprising:
receiving, by the decoder, encoded features from the encoder; and
generating, by the decoder, the output image data based on the encoded features.

7. The computer-implemented method of claim 1, wherein the second uptake time is greater than the first uptake time.

8. The computer-implemented method of claim 1, wherein applying the trained machine learning process to the measurement data and the uptake time data further comprises:
generating uptake time vectors based on the uptake time data;
inputting the uptake time vectors to a neural network; and
based on inputting the uptake time vectors to the neural network, generating uptake time embeddings.

9. The computer-implemented method of claim 8, further comprising:
generating maps based on the measurement data; and
generating modified feature maps based on the uptake time embeddings.

10. The computer-implemented method of claim 1, further comprising providing the output image for display.

11. The computer-implemented method of claim 1, wherein the trained machine learning process is based on a trained convolutional neural network.

12. A non-transitory computer readable medium storing instructions that, when executed by at least one processor, cause the at least one processor to perform operations comprising:
receiving measurement data characterizing a scanned image of a subject;
receiving uptake time data characterizing a first uptake time of the scanned image;
applying a trained machine learning process to the measurement data and the uptake time data and, based on the application of the trained machine learning process to the measurement data and the uptake time data, generating output image data characterizing an output image at a second uptake time; and
storing the output image in a data repository.

13. The non-transitory computer readable medium of claim 12 storing further instructions that, when executed by the at least one processor, further cause the at least one processor to perform operations comprising:
generating feature maps based on the measurement data; and
modifying the feature maps based on the uptake time data.

14. The non-transitory computer readable medium of claim 13 storing further instructions that, when executed by the at least one processor, further cause the at least one processor to perform operations comprising inputting the measurement data to a neural network, the neural network configured to generate the feature maps based on the measurement data.

15. The non-transitory computer readable medium of claim 14, wherein the neural network comprises an encoder and a modulator, and wherein the non-transitory computer readable medium is storing further instructions that, when executed by the at least one processor, further cause the at least one processor to perform operations comprising:
inputting the measurement data to the encoder;
generating, by the encoder, the feature maps; and
modifying, by the modulator, the feature maps based on the uptake time data.

16. The non-transitory computer readable medium of claim 15, wherein the neural network comprises a decoder, and wherein the non-transitory computer readable medium is storing instructions that, when executed by the at least one processor, further cause the at least one processor to perform operations comprising:
receiving, by the decoder, the modified feature maps; and
generating, by the decoder, the output image data based on the modified feature maps.

17. The non-transitory computer readable medium of claim 16 storing further instructions that, when executed by the at least one processor, further cause the at least one processor to perform operations comprising:
receiving, by the decoder, encoded features from the encoder; and
generating, by the decoder, the output image data based on the encoded features.

18. The non-transitory computer readable medium of claim 12 storing further instructions that, when executed by the at least one processor, further cause the at least one processor to perform operations comprising:
generating uptake time vectors based on the uptake time data;
inputting the uptake time vectors to a neural network; and
based on inputting the uptake time vectors to the neural network, generating uptake time embeddings.

19. The non-transitory computer readable medium of claim 18 storing further instructions that, when executed by the at least one processor, further cause the at least one processor to perform operations comprising:
generating maps based on the measurement data; and
generating modified feature maps based on the uptake time embeddings.

20. A system comprising:
a data repository; and
at least one processor communicatively coupled to the data repository, the at least one processor configured to:
receive measurement data characterizing a scanned image of a subject;
receive uptake time data characterizing a first uptake time of the scanned image;
apply a trained machine learning process to the measurement data and the uptake time data and, based on the application of the trained machine learning process to the measurement data and the uptake time data, generating output image data characterizing an output image at a second uptake time; and
store the output image in the data repository.
